(19) United States
(12) Patent Application Publication
(10) Pub. No.: US 2017/0236460 A1
(43) Pub. Date: Aug. 17, 2017

(54) WINCH FOR POSTER HOARDING

(71) Applicant: URBAN STORM MANAGEMENT LIMITED, Oxfordshire (GB)

(72) Inventor: Sam Kimber Ross Cook, Oxfordshire (GB)

(73) Assignee: Urban Storm Management Limited, Blewbury Oxfordshire (GB)

(21) Appl. No.: 15/506,604

(22) PCT Filed: Aug. 26, 2015
(86) PCT No.: PCT/GB2015/052458

§ 371 Date: Feb. 24, 2017

(30) Foreign Application Priority Data
Aug. 26, 2014 (GB) 1415064.3

(51) Int. Cl. G09F 15/00

(52) U.S. Cl. CPC G09F 15/0025; G09F 2007/1839

(57) ABSTRACT

A winch for a poster hoarding comprising a cable management system, the cable management system comprising a plurality of spaced cable guides spaced around a perimeter portion of the poster hoarding, a primary length of cable having a portion that will extend around cable guides around that perimeter when a poster is fitted and tightened within the hoarding, and a cable tightening mechanism for tightening the poster when fitted. The cable tightening mechanism comprises the winch by which a cable tensioning part can be pulled, either directly or indirectly, for tightening the primary cable length between the adjacent cable guides.

### FIELD OF THE INVENTION

The present invention relates to a winch or cable tensioner for a poster hoarding. It is suitable for hoardings onto which a poster can be mounted, for example using clamps, a cable, manual tensioning and then a winch for final tensioning. The present invention also relates to a method of mounting a poster on a hoarding or mount, such as a billboard or a display panel, using such a system.

The present invention also relates to advertising displays and method of displaying advertising.

### BACKGROUND OF THE INVENTION

Posters, such as found on advertising hoardings, have traditionally been held in place by an adhesive rolled on to the hoarding, followed by the poster which is formed of a number of sections of paper, canvas, fabric, bunting, cloth, tarpaulin or textile or the like. In order to mount posters such as banners, billboards, placards, signs, notices or other advertisements, or the like, it is necessary for the person mounting these to place each part in the correct place relative to the other parts so that the poster, as a whole, shows the desired imagery. Once the poster is no longer to be displayed, a new advertisement or the like is generally placed on top of the original in the same way, or the old poster may be removed and replaced with the new poster. Further, access equipment such as ladders, cranes, cherry pickers, scissor lifts or scaffold towers or the like are generally required.

Alternative poster mounting systems have been created such as those provided in PCT/GB2010/000045 and GB1306697.2, the whole contents of which are incorporated herein by way of reference. These have utilised poster clamps around the perimeter of the poster and a cable tightening system linking those clamps, the cable extending around the perimeter of the hoarding for tightening the poster upon the cable being tightened. This system allows quicker poster changes, without a long ladder for accessing the whole poster area, and the poster can be safely installed by a single installer. It also eliminates the need for any form of adhesive on the poster, and it allows backlighting to be fitted behind the poster. However, there remains the desire for poster hoardings to be made easier to install.

The present invention seeks to overcome or address at least one of the disadvantages of the prior art.

### SUMMARY OF INVENTION

The present invention provides a winch for a poster hoarding, or a poster hoarding comprising a winch, the winch comprising an electrical power source, a mounting bracket for attachment thereof to a poster hoarding, a motor, a cable end connector for connecting to an end of a cable of the poster hoarding for tensioning a poster on the poster hoarding, and control switches for operating the motor. In the preferred arrangement, the cable end connector is connected to a shaft, the shaft being for drawing linearly along its own axis upon activation of the motor.

Preferably the motor is electrically driven by the electrical power source. The winch is then an electric winch.

Preferably the winch has a load sensor for allowing control of the motor, e.g. to control winching forces.

The present invention also provides a winch for a poster hoarding, the winch comprising a mounting bracket for attachment thereof to a poster hoarding, a drive member, a cable end connector for connecting to an end of a cable of the poster hoarding for tensioning a poster on the poster hoarding, and a shaft, the shaft being connected to the cable end connector and extending in engagement with the drive member, rotation of the drive member relative to or against the shaft drawing the shaft linearly along the shaft's axis.

The drive member may be one or more worm gear or a threaded hole, or a plurality of planetary gears, designed to engage the shaft for moving the shaft when they rotate, or when the shaft rotates.

Preferably the shaft of either aspect above is a threaded shaft, although it may be a gear rack.

Preferably the drive member has a hole in it, and the shaft extends through the hole.

Movement of the shaft causes the cable end connector to tension or slacken the cable of the poster hoarding.

It is preferred that the winch of any aspect of the invention be removable from the poster hoarding.

It is also preferred to be transportable for use on a plurality of different poster hoardings—poster hoardings provided with a suitable mount for the mounting bracket and a suitable cable for the cable end connector. The cable can be a wire or rope.

In a preferred arrangement, the winch also has a carry handle.

The winch may have an lcd display for indicating the status of the winch. This may include any one or more of battery level, charge status, load readings, target load settings, or other operational status such as whether any control switch, or the motor, is active.

Preferably the cable end connector is in the form of a plate with a connection portion. Preferably the connection portion is, or comprises, a hook.

The cable end connector can be mounted in or on a sliding rail or slot. For some embodiments it is preferred that the rail or slot is linear. Alternatively the cable end connector may have a bearing surface for bearing against another bearing surface, the two bearing surfaces acting together to resist rotation of the cable end connector relative to the poster hoarding. Preferably the two bearing surfaces are flat. One of the bearing surfaces may be attached to the poster hoarding separately to the winch.

It is preferred that the cable end connector has a linear movement relative to an edge of the poster hoarding—preferably parallel to an edge of the poster hoarding that is adjacent a point of attachment thereof to the poster hoarding.

Preferably the motor is a stepper motor. Stepper motors offer a degree of control for the extent of movement of the winch.

Preferably the winch includes a housing for holding together its components. The housing can be a folded plate or a moulded member.

Preferably the winch operates in the absence of a reel thereon, reels being for collection of coiled cable. As such the winch does not collect or release coiled cable thereon. It is possible, however, that the poster hoarding still has one or more reel thereon, for example for the other end of the cable, or if present on the hoarding for cable management as per FIGS. 16 to 20. Such reels, therefore, are restricted to locations on the hoarding, rather than on the winch of the present invention.

It is preferred that the winch operates a linear pull motion on the cable end connector. This can be via a threaded shaft or stud and a rotating nut, or via a gear rack and drive pinion or via a worm drive on the threaded shaft, stud or gear rack.

Preferably the cable end connector is attached to a shaft, rod, stud or gear rack for pulling by the motor or drive member. Preferably the shaft, rod, stud or gear rack is pulled through the motor or drive member. Preferably the motor or drive member surrounds the shaft, rod, stud or gear rack.

Preferably the motor rotates a thread engagement mechanism for driving the shaft, rod, stud or gear rack relative to, or through, the motor. Alternatively the drive member is rotate for driving the shaft, rod, stud or gear rack relative to, or through, the drive member. Alternatively the shaft, rod or stud, for example, is rotated relative to the drive member for driving the shaft, rod or stud relative to, or through, the drive member.

Preferably the switches are press buttons. Preferably there is more than one button.

Preferably there is a retract button. Preferably there is a release button. Preferably there is a stop button.

In a preferred mode of use, the cable tension can be adjusted by operating the motor and then a spring based tension indicator can be checked for tension. When a target tension is indicated the cable can be secured (if not already secured) and the winch can be disengaged therefrom.

Preferably there is a stop button so that a single press on a tension control switch causes continuance of the tensioning, with the stop button being pressed when the correct tension is arrived at.

Alternatively a stop button may be provided for pressing if there is a problem, e.g. if the cable is twisted, or if the poster is not flattening across the hoarding correctly, or if the cable around the hoarding is incorrectly located relative to the edge of the hoarding. This allows the user to concentrate on watching the spring tension indicator, poster hoarding and poster, rather than the winch.

In addition to the spring tension indicator, or instead of it, the winch can have an inbuilt tension indicator—e.g. indicating readings from the load sensor. This may be indicated on the lcd display, where provided, or on a light or other visual indicator on the winch. A traffic light system can be used for this purpose. It can alternatively be an audio signal or a tactile signal such as a buzzer or vibration. The cable tension can thus be indicated from the load sensor using the indicator. This can be a simple indication of determined load data, or data relative to preset load targets. For example, a preset or target load may be programmed into the control circuitry of the winch, and the traffic light can be indicative relative thereto. On other arrangements, the motor control may be controlled automatically by load data, such as automatically to stop when a target load is achieved.

The winch preferably has a sensor for the cable end connector to detect the position of it, such as when it reaches a full extension or a full retraction. This can allow the controlled operation of the motor such that the cable end connector cannot extend too far either inwardly or outwardly through operation of the motor.

The invention also allows for a manually driven embodiment—i.e. a winch without a motor, and without a battery. For example, the winch may have a handle driven driveshaft, e.g. with a removable handle—such as a ratchet handle.

More preferably the motor is a separable motor—such as a drill—e.g. an electric drill, and most preferably a cordless drill.

For easy attachment to a drill, the winch preferably has a chuck-piece for connection into to a chuck of the drill. The chuck-piece may have a three-sides arrangement, or a six sided arrangement for easy mounting to such a chuck—most cordless drills operate a three fingered chuck. A six sided chuck-piece is preferred, however, since it can also be more ready connected to by a wrench or socket (e.g. with a ratchet handle) than a three sided chuck-piece. The chuck piece may be removable for allowing different chuck-pieces to be applied—some users may prefer different forms of chuck-piece.

Preferably the range of extension and retraction of the cable end connector in the winch cannot exceed 60 cm. More preferably it cannot exceed 45 cm. In the preferred embodiment, the range of movement is governed by the length of the rod.

Preferably the rod is a threaded rod.

Preferably the motor has a worm gear or a rotatable nut within the stepper motor for driving the threaded rod. Other modes of advancing a rod along its longitudinal axis are also within the scope of the present invention, as will be apparent to a skilled person in the art.

Preferably the winch has a programmable control card. The programmable control card can provide functional control for the winch, for example for the motor such that the tension feedback can be analysed and used to control the motor so that an automatic stop can be provided in the event of a predefined tension. Alternatively, or additionally, it can be monitoring the extension or retraction of the cable end connector relative to the motor so as to automatically control the motor to prevent over retraction or under retraction.

Preferably the mounting bracket comprises at least one hook. Most preferably it comprises at least two hooks for notching onto two bolts on the hoarding. Two provides greater stability than one. Where more than two are provided, there can be increased variation as to the location of attachment, although flexibility may be hindered if the hoarding is not suitably adapted to receive such an arrangement.

In another arrangement a bracket is bolted onto the frame and that frame provides a releasable attachment point for the drive components of the winch—such as by having two slots, or two pairs of slots, for engaging a base-plate of the winch's drive member.

Preferably the base plate is an L-shaped member with a foot that engages the frame (or the bracket on the frame—e.g. on the hooks or slots, and a leg that stands upwards therefrom for receiving the drive member—preferably a nut, the shaft still extending therethrough towards the end of the hoarding's tensioning cable (connecting thereto using the cable end connector).

Preferably there is a second bracket—for providing a bearing surface for the cable end connector—the cable end connector having a face for bearing against that second bracket—preferably on an upstanding leg that extends perpendicular to the leg of the base plate.

Preferably the cable end connector and rod has a slot or rail connection along two sides thereof so as to provide stability as it slides or moves relative to the motor. This can advantageously offer good rotational stability for the cable end connector and rod, e.g. to prevent twist of the cable end connector and rod relative to the motor.

The winch can be fitted onto a poster hoarding comprising a cable management system, the cable management system comprising a plurality of spaced cable guides spaced around a perimeter portion of the poster hoarding, and a cable for the poster.

It is preferred that the poster hoarding has a primary length of cable having a portion that will extend around cable guides around that perimeter when a poster is fitted and tightened within the hoarding, and a cable tightening mechanism for tightening the poster when fitted, the cable tightening mechanism comprising:
the winch, by which a cable tensioning part can be pulled, either directly or indirectly, for tightening the primary cable length between the adjacent cable guides.

Preferably the cable tightening mechanism further comprises a geared winder having:
a first component for winding up cable slack in that primary length of cable as the cable tensioning part is pulled and a smaller second component from which cable can be unwound as the cable tensioning part is pulled, the relative sizes of the first component and the second smaller component gearing the effect of the pulling such that the length of the primary length of cable that is wound up by the first component as the cable tensioning part is pulled is longer than the length of pull of the cable tensioning part.

Having a geared winder is beneficial for the design of the winch—since the winder on the hoarding is geared, the length of the pull required by the winch is short, and thus the length of the rod or shaft can also be short. This allows a linear pull to be used by the winch.

Note too that in normal use, the majority of any slack used for allowing the attachment of the poster to the primary cable can being taken up manually, for example onto the geared winder. The poster is not heavy so the loads involved are small. The winch is only needed for applying final tension—a tension that is advantageously controlled—to ensure a correct fitting of the poster across the face of the poster hoarding for it to withstand wind shear, and relatively tight, which tension is thus hard to apply manually, and which conventionally has been applied via a manual reel-based winch, or a manual lever and spring arrangement.

Preferably the cable tensioning part is a cable end. Preferably it has a carbine hook on its end for quick connection to a pulling mechanism.

Preferably the length that the cable tensioning part is pulled is the same as the length of cable unwound from the smaller second component, i.e. there is no gearing between those parts.

Preferably the pulling of the cable tensioning part is by a winch operated by the user, whereby the pulling is itself geared by the winch. The winch may have a cable on it with an end for attachment to the cable tensioning part, e.g. via the carbine hook.

In the same way that the geared winder can gear up the effect on the primary length of cable of the pulling of the cable tensioning part, the geared winder will also gear up the slackening of the primary length of cable, i.e. unwinding the wound up slack of the primary length of cable to present slack back into that cable for allowing the poster to be released, lowered and changed.

Preferably there are at least two distinct cables, one defining the primary length of cable and the other defining the cable tensioning part. Preferably the first is attached to the first component and the second is attached to the smaller second component.

Preferably the cable tightening mechanism comprises a spring-based tension guide. Preferably it is detachable from the cable tensioning part, between the cable tensioning part and a mechanism for pulling that cable tensioning part. Instead of the spring-based tension guide, or in addition thereto, the winch may provide a tension indicator, or an automated tension cut-out, e.g. for cutting out the winch at a preset, or adjustably pre-settable, tension.

Preferably the cable guides are located at four corners of a square or rectangular poster hoarding. The poster therefor will therefore be generally square or rectangular. Other shapes of poster/poster hoarding can also be provided, e.g. a suitably shaped poster hoardings, such as round, triangular or multi-sided, for a correspondingly, or suitably, shaped poster.

Preferably the geared winder is on a back-plate of the hoarding, within the confines of an outer frame of the hoarding.

Preferably the first component of the geared winder is a wheel or reel. Preferably the wheel or reel is round or formed of spaced members that describe a circular shape. Preferably the diameter of that circle is at least 60 cm, and more preferably it is about 1 m.

Preferably the smaller second component of the geared winder is a wheel or reel. Preferably the wheel or reel is round or formed of spaced members that describe a circular shape. Preferably it has a diameter no more than half the diameter of the first component, and more preferably it is about a third of the diameter of the first component.

The gearing of the geared winder is a function of the respective circumferences or perimeters defined by the first component and the smaller second component, and is thus proportional to the respective diameters, where circular. Preferably the gearing is at least 2:1, although a preferred embodiment has it at about 3:1.

Preferably the primary length of cable has a first fixed end, and from that end, when a poster is installed and tightened within the hoarding, it then extends all the way around the perimeter portion of the poster hoarding around each cable guide in turn before then extending towards the first component of the geared winder. Preferably it has a second end attached to that first component. It will have a wound length wound around the first component when it is in its tightened state (i.e. when a poster is installed and tightened within the hoarding). That wound length defines the amount of slack provideable by the unwinding of the first component.

Preferably cable tensioning part has a first end for attaching to a winding mechanism, either directly or indirectly, and from there it extends along a portion of the perimeter of the hoarding, preferably a bottom portion, to one of the cable guides, and from there it then extends to the smaller second component of the geared winder. Preferably it has a second end attached to that smaller second component. When the primary length of cable is in a slackened state, the smaller second component will have a wound length of cable on it.

A poster to be displayed can be attached to the primary length of cable using clamps, the clamps preferably fixedly engaging the edges of the poster and slidable engaging the primary length of cable. By using clamps of the type defined in the above-mentioned PCT application, or other hook-based attachments, this most usefully can be achieved without access to an end of the primary length of cable—such clamps can be hooked onto the cable, rather than needing to be threaded onto the cable via a free end of the cable. The clamps might, however, be pre-threaded onto the cable, i.e. before attaching its ends to the hoarding and first component, respectively, where that has been done.

Once the poster is attached, if the cable needs locating around the cable guides, that can be done next. A pole may be used to grasp the cable such that it can be pushed over the cable guides. Likewise, earlier the pole can be used to pull the cable/old poster down to the working height, which may be ground level, or at the height of the bottom of the perimeter of the hoarding. This invention therefore removes or reduces the need for long ladders or cherry pickers for the process of fitting or replacing a poster in the hoarding.

After connecting the clamps to the poster, and to the cable, if needed in the circumstances, the cable is drawn manually tight by hand, for example, where fitted using the cable management system. The poster as a result is then pulled generally to the outer edge of the hoarding and held in initial tension. The winch can then be connected and operated to apply final tension when needed. Alternatively the winch can operate the full tensioning from slack through the cable management system—or through another gearing system for picking up the slack quickly.

When the poster is to be removed, the cable is loosened or slackened for enabling access to all the clamps from ground or standing height level, or at the bottom portion of the perimeter of the hoarding, if appropriate. This again can be manual or using the winch. In general it is a removal of the clamping effect of the cleat that allows the loosening of the cable. The poster can then be released from the clamps (if the clamps are to be reused), or the clamps can be released from the cable (if the new poster to be fitted is pre-fitted with clamps), and a new poster can then be fitted either to the old clamps or to the cable. The cable is then again drawn back tight to complete the installation of the new poster.

A cleat is preferred to be used for securing the tension in the cable for a fitted poster, whereupon the winch, and even the spring tension guide, where provided, may be removable. This allows a narrower hoarding to be provided—space is not needed for a permanent winch.

Prior to final tensioning, the cable may need to be linked or fitted on to additional cable bearings, guides or hangers, typically ones that are evenly spaced around the perimeter of the hoarding, e.g. between the main cable guides, and this can be done again using the long pole, which may have a cable gripping or grabbing end feature. These additional cable bearings, guides or hangers are to ensure that there is no excessive droop in the cable when under tension, which droop could cause excessive distortion of the poster across the face of the hoarding.

In an alternative arrangement the cable may be pre-threaded around loop bearings from which the wire cannot escape. Such loop bearings, or other bearings that retain or encapsulate the cable are most preferred at least in the corners of the hoarding, and thus are preferably the form of the main cable guides. Cable tension can retain the cable in non-encapsulating bearing members, and re-hooking the wire around the edges of the hoarding, as opposed to at the corners, is relatively simple while the cable is not under tension, so long as the cable is correctly hooked on or retained in the corner cable guides.

The winch of the present invention may also be fitted to a poster hoarding comprising a cable-based poster tensioning mechanism, that tensioning mechanism comprising a plurality of cable guides spaced around a perimeter portion of the poster hoarding, the winch, once fitted, a primary length of cable having a portion that will extend around the cable guides around the perimeter when a poster is fitted and tightened within the hoarding by the tensioning mechanism, and a cable tension retention mechanism for holding the cable in a tensioned condition, the cable tension retention mechanism being able to retain cable tension within the cable-based poster tensioning mechanism after removal or disengagement of the winch.

Preferably the cable tension retention mechanism is a cleat, a clutch or a rope jamming mechanism.

Preferably the end of the cable that is tensioned comprises a length of rope for fitting in the cable tension retention mechanism—e.g. a running cleat or a cam cleat.

Preferably the end of the rope or wire or cable is fitted with a shackle or carbine hook for easy attachment to, and separation from, the winch.

Preferably the winch is removable from the poster hoarding after use.

Preferably the winch is fitted to a slot in the hoarding. Preferably it is retained therein by one or more hook. Preferably the hook or hooks are on a flange. Preferably the flange is adapted to fit into the slot so that one or more hook thereon can engage on a respective number of pins therein. The or each pin may be a bolt that extends across the slot. The hook or hooks can engage on the pin or pins in a direction such that tensioning the cable prevents a detachment of the hook or hooks from the pin or pins.

Preferably between the winch and the end of the cable to be tensioned, a tension guide is provided. Preferably the tension guide takes the form of a spring tension guide. It can provide an indication when an appropriate tension is applied to the poster/cable. As before, however, this can be replaced by or supplemented by, tension control arrangements in the winch.

By having the cable end securable in the cable tension retention mechanism, that tension retention becomes independent of any tension applying mechanism. Therefore, the tension applying mechanism, i.e. the winch, need not remain in or on the hoarding once the tension is applied and retained. As a result it becomes optionally a removable component of the hoarding. As such, the tension applying mechanism can be used for multiple hoardings, thus allowing the hoarding to be less costly—the tension applying mechanism, which may be a winch, is sometimes a relatively costly component of the hoarding.

Additionally, having the tension applying mechanism as a removable component allows the frame component of the hoarding to be made smaller (either or both thinner and less wide). That is because the frame component would not need to be sized to accommodate the tension applying mechanism, such as a winch or lever mechanism. The frame component may comprise a frame cover and a frame casing. If smaller, they could both be extruded in a less costly manner since it can be the dimensions of the extrusion die that dictate the cost of the extrusions.

Even if not extruded, e.g. if instead the frame components are fabricated, the fabrication utilises less materials and thus will again be less costly.

Preferably the tension retaining mechanism is a running cleat, whereby as the cable or rope end is pulled through it, it automatically prevents retractions thereof. It can even be a chain-cleat, whereby the cable can have a chain component at its end that runs through the cleat.

In a preferred embodiment, the tension retaining mechanism works such that the cable, rope or chain can pass through it, with the cable, rope or chain being pullable in one direction through it (the cable tensioning direction), but such that the cable, rope or chain locks in it if attempted to be pulled in the opposite direction.

Preferably it is a cleat with these features, and for that purpose it might comprise a pair of rotating grips or cams, with opposing faces, between which the cable, rope or chain extends.

The tension retaining mechanism may be releasable, i.e. the tension can be allowed to release, by lifting or bending the cable, rope or chain out of the top or side of the clear, Alternatively, a button, a handle or a lever may be used to release the retention.

Embodiments other than a cleat may take the form of a clutch or rope jamming mechanism.

Suitable clutches, cleats and running cleats are readily available from sailing accessory stores. A particularly suitable cleat is sometimes sold as a cam cleat.

Other forms of cleats, especially those that allow a running rope to automatically lock upon reversing its direction of movement, are also suitable.

According to another aspect of the present invention, there is provided a poster hoarding having a cable based poster tensioning mechanism therein, the poster tensioning mechanism comprising a length of cable, rope or chain that runs along a leg or arm of the poster hoarding to a cable tensioning point, the cable tensioning point being adapted to allow a cable tensioning mechanism to be used for pulling the cable, rope or chain for tensioning the cable, rope or chain to tighten a poster, the cable tensioning mechanism comprising a winch as previously described.

Preferably the cable tensioning point comprises a housing and a connection point onto or into which the winch can be fitted for tensioning the cable, rope or chain.

Alternatively, the winch may be pre-fitted at the cable tensioning point.

The cable, rope or chain may run through the leg or arm, or on the outside of the leg or arm.

Preferably the cable, rope or chain is protected, such as with a casing, or by being within the leg or arm, such that access thereto is not readily available—it needs to not be accessible to the public so as to offer security for the poster/cable mechanism—if cut, the poster or mechanism would be free to come loose from the hoarding.

The cable tensioning point is at a position that is remote from the frame of the hoarding, typically on a leg of the hoarding, although it may be elsewhere remote from the frame of the hoarding. This allows a higher hoarding to be provided, since direct access to the frame of the hoarding is no longer necessary for servicing posters within the hoarding—that servicing can instead be achieved from a lower, or remote, position relative to the frame of the hoarding.

Preferably one or more pulley is provided for diverting the cable, rope or chain within the frame of the hoarding, either down or across towards the remote position.

Instead of being lower (e.g. down the leg), it may be to the side of the hoarding, e.g. along an arm of the hoarding. This is beneficial in particular for installations where the hoarding is located itself in an inaccessible location—the poster hoarding can still be serviced (posters replaced) from the remote position—i.e. an accessible location just next to the inaccessible location. This would be via the remote tensioning mechanism.

A pole with a hook can be utilized for grabbing the poster, or for hooking the cable over the cable guides of the poster tensioning mechanism, to further avoid the need for direct access to the framed area of the hoarding. Thus, full servicing is achievable remote from the frame.

This aspect of the invention, as with the other aspects of the invention, can be utilised with each of the other aspects.

Since the winching mechanism will not be within the frame in this aspect of the invention, clearly again a thin frame component, as per the previous aspect, would be useable.

According to another aspect of the present invention there is provided a poster mounting system or apparatus or a poster hoarding as defined above, further comprising a guide frame or guide frame members over which the poster is tightened as the cable is drawn from a slackened condition into a tightened condition, the guide frame (or the frame members) providing an edge over which the poster will flatten to provide a flat finish to the area of the poster lying within the guide frame. The tightening of the clamps onto the edges of the poster, and the tensioning of the poster by the resulting clamp-point attachments, can otherwise cause the poster to assume a somewhat creased or rippled finish. That creased or rippled finish is flattened out by the guide frame, at least for the area of the poster lying within the guide frame, i.e. the area that is viewed from outside the housing.

Preferably the hoarding comprises edge covers, which may be hingedly attached to the hoarding. The edge covers are provided to hide the parts of the tensioning mechanism that lie outside the edge of the guide frame, and the clamps.

Where the guide frame is not provided, the edge covers cover the clamps and any parts of the tensioning mechanism lying outside the area circumscribed by the clamps.

Preferably the hoarding is square or rectangular, and the guide frame consists of at least four frame members—one for each side, each having a rounded edge over which the poster can be tightened. It is also envisioned that a side may have two or more linearly aligned frame members therealong.

Preferably the guide frame has a generally saw-tooth cross section, the tip defining the edge over which the poster is drawn to tighten it into a flat configuration. That tip is preferably rounded to a radius of not less than 2 mm, although a flat edge is also possible.

The guide frame generally matches, or is larger than (so as to be covered thereby), the shape of the inner edge of the hoarding's external frame, i.e. the frame that defines the aperture through which the poster is viewed by the public.

Another aspect of the invention provides an advertising display or poster hoarding as defined above, further comprising a light for providing illumination. The light may be an array of lights. The light may be for illuminating the outside of the poster, or it may provide back-lighting. Preferably it provides back-lighting. Preferably it is in the form of LED strips, which for backlighting will extend behind the poster.

The light may be arranged to provide differing illumination, which illumination may be controllable or programmable to be different for different advertisements. The particular type, colour, pattern or brightness, for example, of the illumination emitted from the light (preferably the LED strips), may be correlated with the theme or branding of the poster's image.

The light or lights, such as the LED strips, may be arranged to produce a plurality of colours of illumination, each colour being provided to correspond with or suit a different advertisement displayed in the display, e.g. if the poster has more than one advertisement on it.

The light may be arranged to illuminate a surround of the advertisement display.

The light may be arranged to vary the illumination during the display of a particular advertisement.

Preferably the system of the present invention uses a set of poster clamps for attaching the poster to the primary length of cable. Preferably each poster clamp comprises first and second members, the members comprising first and second gripping surfaces, respectively, for gripping opposing sides of a poster or the like.

The two members can be arranged for pivotal movement with respect to one another and can have a clamping device for clamping the two surfaces towards one another.

Either one or both of the surfaces may be gripping surfaces, i.e. surfaces with surface features to enhance grip.

Further details of a preferred clamp are provided in the above-mentioned PCT application.

According to another aspect of the present invention, there is provided a method of mounting a poster onto a hoarding. The method may make use of the above-mentioned systems, apparatus or hoardings and can make use of one or more poster clamps as defined above or below.

### BRIEF DESCRIPTION OF THE DRAWINGS

Embodiments of the present invention will now be described, purely by way of example, with reference to the accompanying drawings in which:

FIG. 1 shows a prior art cable system for a poster hoarding which can utilise the present invention;

FIGS. 2 to 4 show an example of a poster clamp that can be used for attaching a poster to a cable in a poster hoarding that can utilise the present invention;

FIGS. 5 to 7 show a prior art cable system for a poster hoarding fitted with a winch, with FIGS. 6 and 7 showing details from FIG. 5;

FIGS. 8 to 13 show a poster hoarding with a cable system that can utilise the present invention, but instead utilising a winch with a conventional reel;

FIGS. 14 and 15 show a first embodiment of a winch of the present invention;

FIGS. 16 to 19 show a poster hoarding with a cable management system incorporated thereon—the cable management system utilising two differently sized reels to provide gearing for the tensioning and loosening of the cable of the poster hoarding;

FIG. 20 shows a variant of poster hoarding in which the winch is located down the leg of the hoarding, rather than on the frame thereof;

FIGS. 21 and 22 show a second embodiment of winch in which the tensioning is carried out using a removable motor or ratchet handle;

FIG. 23 shows the winch of FIGS. 21 and 22 from an end view—detailing its location within the frame's surround; and

FIGS. 24 to 31 show a variant of the winch of FIGS. 14 and 15 in which the battery is removed, it instead being powered by a local power source to the poster hoarding, or by a separable battery pack (not shown).

In some figures, certain details, back-boards or hoarding/cable covers may have been removed for allowing hidden items or other components to be visible.

### DETAILED DESCRIPTION OF EMBODIMENTS OF THE INVENTION

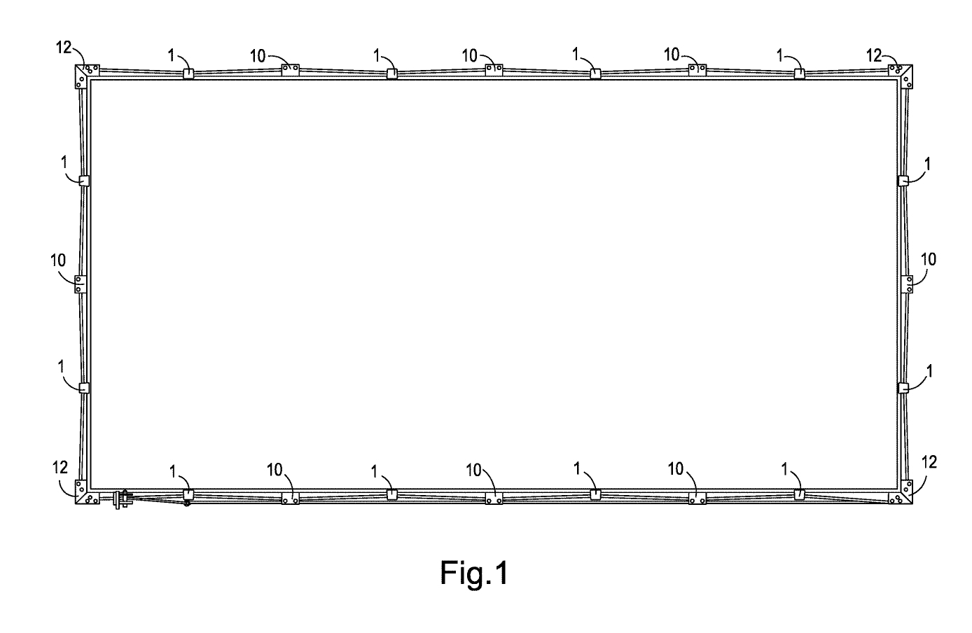

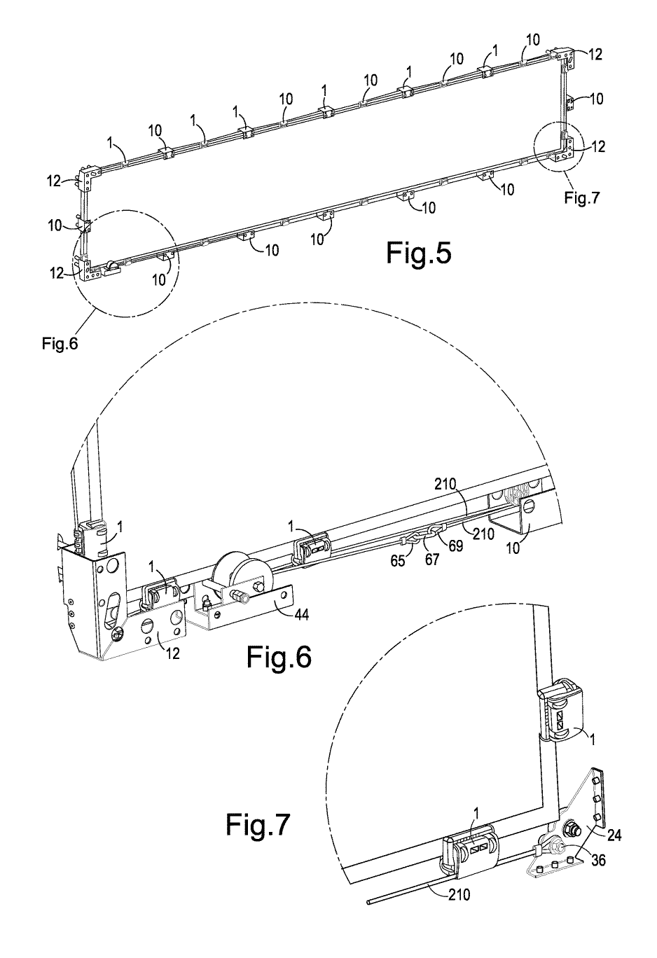

Referring first to FIGS. 1 to 7 two sizes of poster hoarding, and a type of poster clamp 1, are shown. FIG. 1 represents perhaps a 3×6 m poster hoarding, whereas FIG. 5 shows perhaps a 1×6 m poster hoarding. Other sizes of poster hoarding can also utilise the present invention. Likewise, different cable arrangements and different clamps can be used.

As can be seen in FIGS. 1 and 5, and then in greater detail in FIGS. 6 and 7, these hoardings utilise a cable or wire based tensioning system that involves a wire or cable 210 that is provided in a ring or a loop around the edges of the hoarding. The ring or loop of wire can be tightened by a tightening mechanism—in this embodiment, a winch 44.

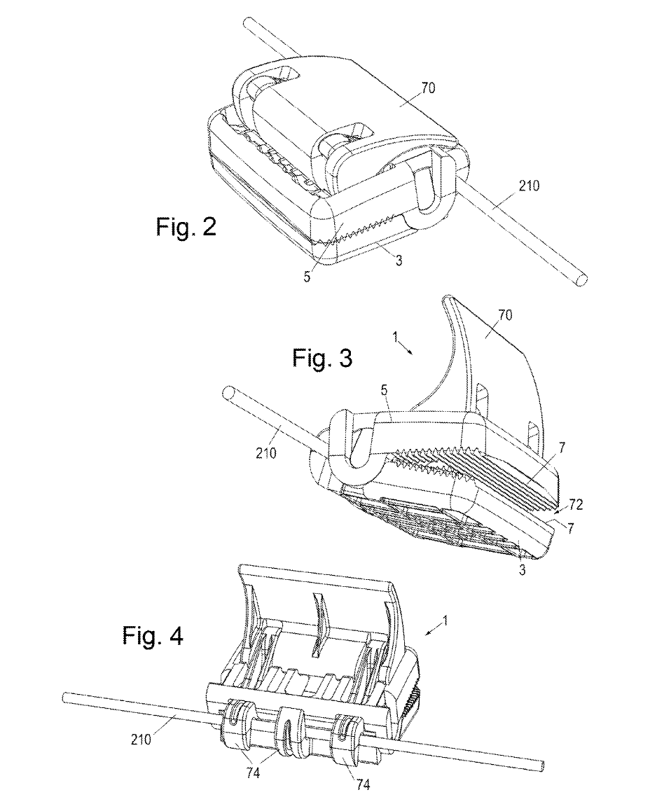

To hold a poster on the hoarding, the wire 210 can receive a plurality of poster clamps 1 such as those disclosed in FIGS. 2 to 4, or in FIGS. 6 and 7, or as described in PCT/GB2010/000045, the whole contents of which are incorporated herein by way of reference.

In the arrangement of FIG. 5, one free end of the wire or cable 210 is fixed 36 in a corner bracket 24 of the mount—see FIG. 7.

The wire 210 then passes through loops, or on clips or bearings, i.e. cable guides, around the edge of the hoarding, or the mount. The wire 210 can slide through or over these loops or bearings. Loops may take the form of simple eye screws, or may be customised guides with grooves provided therein. The guides might even have pulleys in them for assisting in guiding the wire when it is tightened from a slack condition. Such pulleys are preferred wherever there is a substantial cable direction change, e.g. the corners.

The loops or bearings or guides, especially any without pulleys, may be made from or with a low friction material, or may just have a low friction coating, such as PDFE, for assisting with that wire guidance to prevent excessive resistance to tightening.

As mentioned above, the wire is fixed to the mount. This occurs at a fixing point 36, which is preferably at a corner of the mount or hoarding, although it might be elsewhere around the mount or hoarding.

The clamps are releasably attachable to the wire and to a poster, as described in greater detail in GB0818052.3 and the above PCT application, the contents of which are incorporated herein by way of reference.

The clamps are retained on the wire upon tensioning the wire—the wire cannot then easily be bent out of the clamp's wire-engaging mechanism—the multiple hooking mechanisms 74 resist such a removal by facing in opposing directions—see FIG. 4. However, when the wire is loose, poster clamps which connect the poster to the wire loop can be attached to the wire 210 by bending it around those hooking mechanisms 74.

Since the cable is longer than the loop, when the wire is loose, it can be pulled preferably at least down to the bottom edge of the hoarding's frame so that all the clamps can be attached to the cable, or pre-attached cables can be attached to the poster, down at that level. More preferably the wire or cable 210 can be drawn down to ground level (or to a base level) to make the attachment even safer—no climbing equipment such as ladders or the like is needed. A hook, perhaps on a pole, might be needed to pull the loop down, or to free it from cable guides (where possible). This ensures that less climbing is needed than would otherwise be needed.

Once mounted to the wire, as the wire is tightened with the tightening mechanism, e.g. the winch 44, the wire will slide through the corner cable guides (e.g. the pulleys) such that the poster is pulled to the edges of the poster mounting for opening out the poster in full. The pole and hook can then lift or place the wires at the edges of the poster over any remaining cable guides before a final tightening of the wire or cable 210 for tightening the poster across the face of the hoarding.

When the poster is to be removed, the wire 210 is again slackened. This is for example by releasing the winch 44 for allowing the tension in the wire to be reduced. This then allows the wire to be moved away from the edge of the hoarding, e.g. off the cable guides. Once that has occurred, the clamps may then be removed from the wire, and/or the poster removed from the clamps.

Often the poster will be removed from the clamps without removal of the clamps from the wire—the clamps can be reused. Sometimes, however, the poster will arrive with poster clamps pre-fitted, and thus it just needs to be fitted onto the wire or cable instead of the old poster and clamps.

Any poster clamp that can engage the edge of a poster, and also the wire, can be used in this system.

FIG. 1 shows a possible positional arrangement for the poster clamps 1 and bearings 10, 12 on a poster mounting system of the invention. The poster clamps 1 are roughly equally spaced around the perimeter of the billboard —2 on each side and for at the top and bottom. It is possible, however, that additional poster clamps 1 will be provided, for example closer into the corners of the poster. Likewise they may be more closely spaced apart around the edge of the poster. This can give a better or flatter tightening of the poster when the cable is tightened.

FIG. 5 illustrates an alternative poster hoarding with a different clamp arrangement—two clamps are provided on each side—but nearer the corners, and 6 are provided at the top and bottom.

Typical spacings between clamps 1 may be between 500 and 800 mm, although other spacings are possible too.

Adjacent the corners, the spacing from the clamp 1 to the corners is preferred to be much less, For example, the distances may be between 100 mm and 300 mm. By making that distance smaller, it is possible to ensure that the poster correctly tightens not just along the sides of the poster, but also into the corners of the poster.

As seen in FIG. 1, the poster clamps 1 are typically located between a pair of bearing members 10 along the sides of the poster mounting system and between the corner bearing members 12, four of which are provided in this embodiment, and an adjacent side bearing member.

The arrangement shown in FIGS. 5 to 7 clearly illustrates four corner bearing members 12 and twelve side bearing members 10. In this embodiment there are five side bearing members 10 along each long edge and one on each short edge. This should be adequate for a poster of approximately of 6×1 meters. Other numbers are possible, as may become appropriate depending upon the size of the hoarding, and the strength of the medium onto which it will be mounted.

Clamps 1 are also shown in these drawings. They are engaging an edge of a poster. One clamp 1 is illustrated between each pair of side bearing members, or between each corner bearing member and its adjacent side bearing member 10. However, additional clamps 1 may be used in practice. They will generally be located, however, such that they won't foul against the bearing members.

Referring next to FIGS. 2 to 4, a brief description of a clamp will be provided. The clamp comprises a first member 3 and a second member 5. Between the first and second members 3, 5 is a pivotal connection. The clamp also comprises a third member 70.

As illustrated in FIG. 3, the first and second members, 3, 5, both have gripping surfaces 7. Each gripping surface 7 is formed from a plurality of parallel grooves. The grooves extend between the sides of the first and second members, i.e. parallel to the wire 210 once the clamp 1 is mounted thereto.

The grooves are formed by serrations that have an approximately equilateral section. Preferably, the point angle of the triangle is between 75 and 40°, although angles of about 70°, 60° and 50° have been found to be suitable for providing an adequate grip. The most preferred angle is approximately 50°. Other shapes can also be used, for example saw-tooth arrangements with non-equal sides, or rounded shapes.

The grooves of the first member 3 are displaced relative to the grooves of the other member 5 so as to allow the serrations to intermesh upon clamping the clamp into a closed position. This allows a poster to adopt a shape generally corresponding to the grooves so as to increase the clamping strength of the poster within the jaw 72 of the clamp 1.

Grooves other than parallel grooves might be provided instead of the parallel grooves. 5 Further, in place of the grooves, other shaped gripping means can be provided.

Referring next to FIG. 4, three hook members 74 are illustrated. Those hook members 74 are for hooking the clamp 1 onto the wire 210.

Two of the hook members point their openings in one direction and the third (middle) hook member points its opening in the opposing direction. This is to prevent the inadvertent release of the clamp 1 from the wire 210, such as while the wire 210 is extending in a straight line between the hook members 74 (i.e. in a condition where the wire 210 has been tightened). In order to disengage the wire 210 from the hook members 74, the wire 210 will therefore need to be slackened. Then it can be bent around the hooks 74. The clamp 1, therefore, is securely retained on the wire 210, albeit in a manner that allows it to be easily removed therefrom, if desired by a user.

As is readily apparent from the drawings, the three hook members 74 are spaced apart relative to one another along the length of the wire 210. That spacing allows the wire to be removed from the hook member 74 upon bending it around the hook members 74.

All three hook members in this embodiment are attached to a rear edge of just one of the first and second members 3, 5. In this example that member is the first member 3. This means that the hook members 74 are in a permanently fixed position relative to one another.

Additional hook members can be provided too, e.g. to improve the robustness of the connection to the wire.

Other clamping or gripping mechanism can also be utilised. The present invention is not limited to this form of clamp 1.

Preferably all three members 3, 5, 70 are moulded components made of a tough plastic material, e.g. a GRP. Many suitable plastics are known in the art. The clamp might alternatively be made from a metal casting, or by some other well established method or material.

Typically the clamps are approximately 7 to 8 cm wide, 3 to 4 cm deep and 6 to 7 cm long. Typically the grooves in the gripping surfaces are between 1 and 2 mm deep.

Other sizes, e.g. for smaller or larger posters, could also be made.

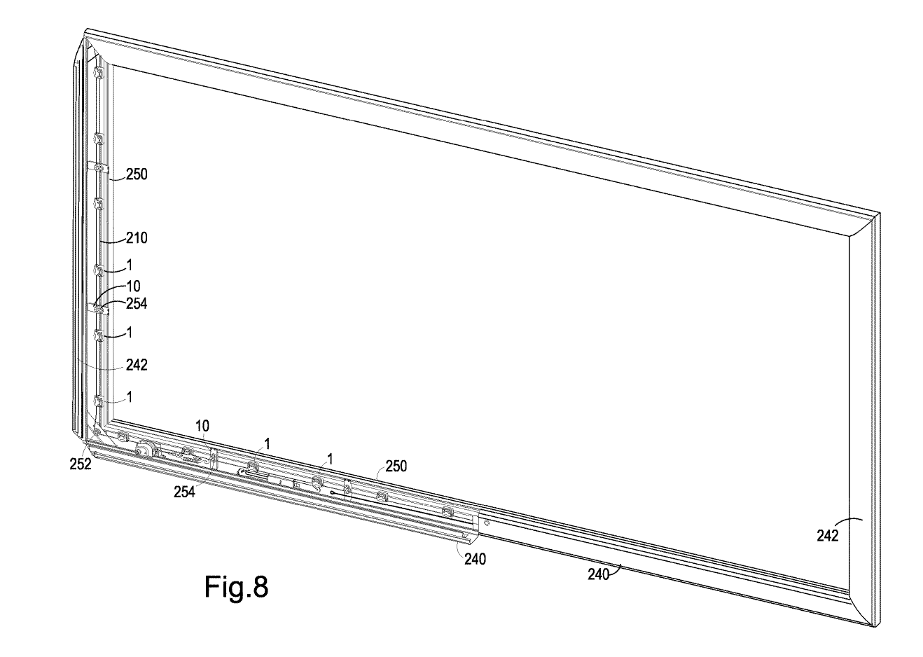

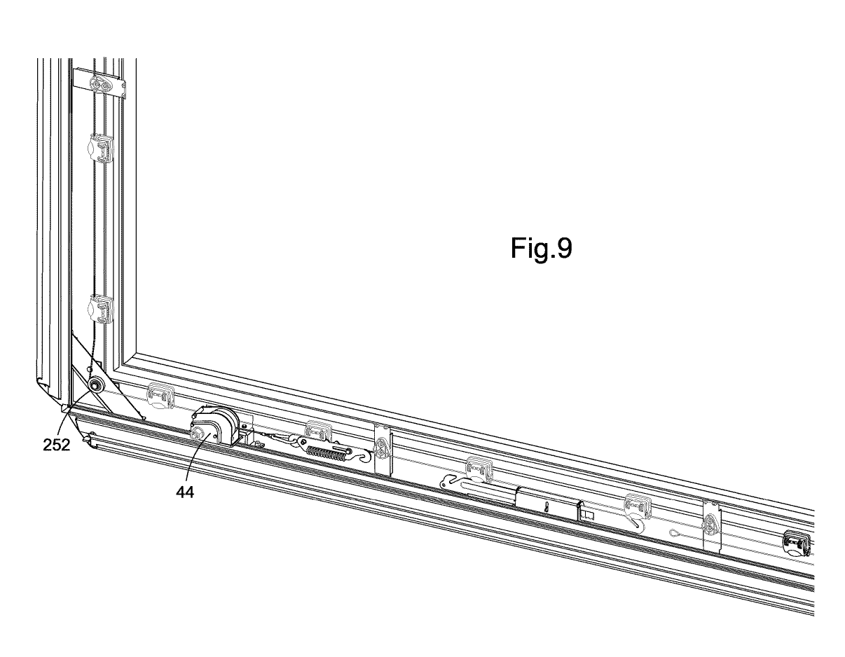

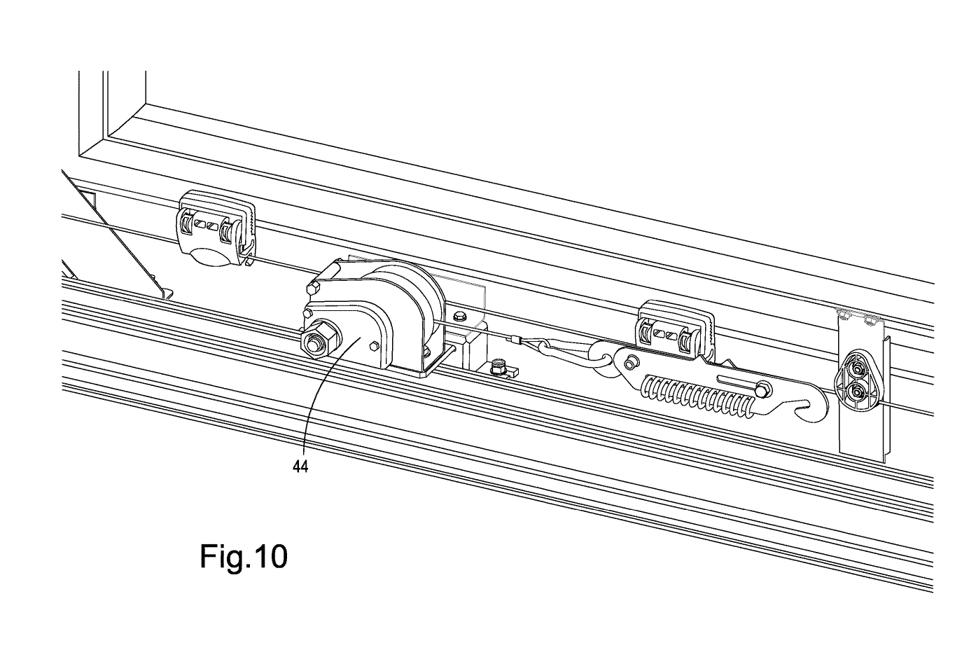

Referring next to FIGS. 8 to 10, a poster hoarding is disclosed. This has a frame surrounding an aperture in which a poster can be displayed. The frame has a top, a bottom, a left and a right. The top and bottom are each comprised of two front covers 240, one of which is shown to be open on the bottom edge. The sides each comprise a single cover 242, the left one of which is open as well. By being open, clamps 1 can be seen, although these are not shown here to be connected to a poster. In normal use, however, a poster would be present and the covers would all be closed.

In FIGS. 8 to 10, the cable 210 can be seen. It extends around the aperture for allowing the clamps 10 to tension a poster across the aperture.

This embodiment also has a guide frame 250 over which the poster can be tightened to provide a flat finish to the poster.

There are also pulleys 252 in each of the corners (one shown), which pulleys may be a double pulley in the bottom corner as shown since the loop of cable will extend through more than one loop around the hoarding in that corner—to provide a length for tightening the cable, as opposed to the length that provided the positions at which the poster is attached.

The frame also has further cable guides 254 on mounts 10. These are for hooking the cable onto when tightened, or prior to a final tightening, so as to correctly locate the poster within the aperture.

There is also a reel-based winch 44, provided for applying tension to the cable, as necessary for tightening it. This winch 44 is removable in this embodiment, and is thus replaceable with the winch of the present invention as a preferred means for tensioning. Because it is removable, this also means that the frame covers can be more flush with the poster (or the thickness of the frame boxes can be smaller—the winch does not need to be contained behind the covers, i.e. in the frame box).

Having such a slimmer frame provides a more slim appearance to the hoarding as a whole, especially where no light-box is needed behind the poster. This is therefore a preferred arrangement.

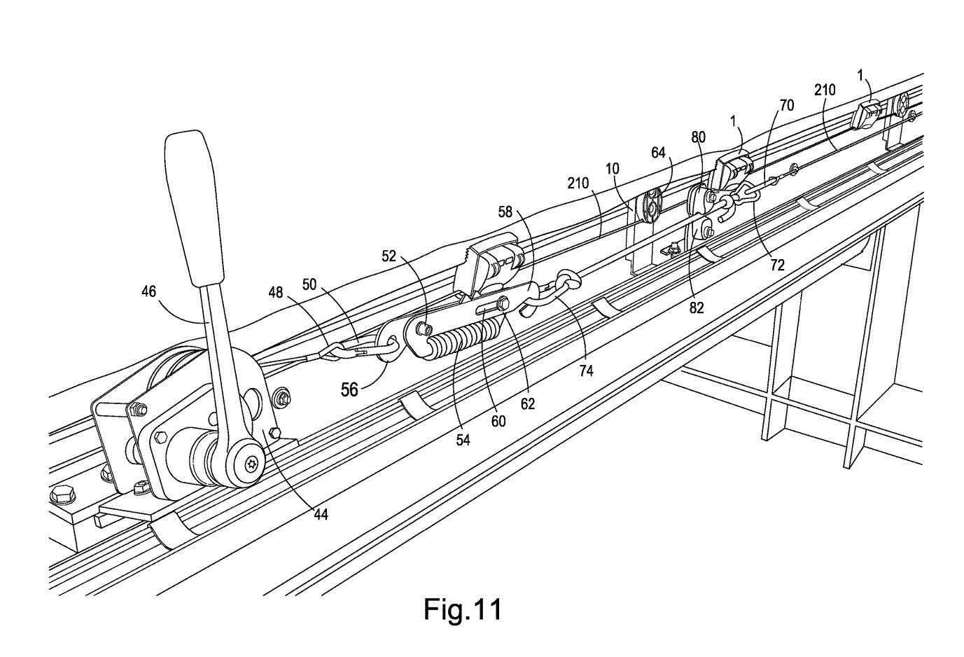

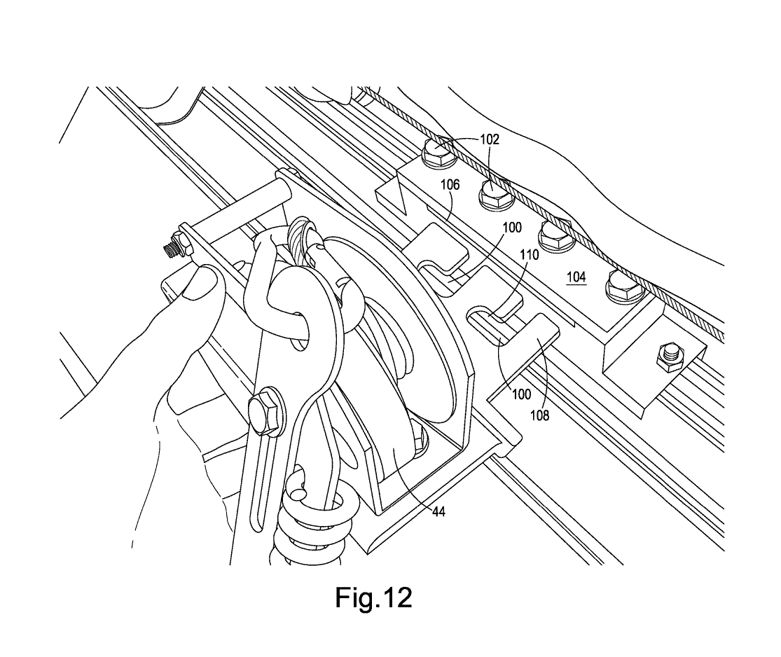

Referring then to FIGS. 11 and 12, again the winch 44 is shown. It has a removable handle 46, as before—a ratchet handle, and is fully removable too.

The cable end 48 extending from the winch has a carbine hook 50 on its end for connecting it to a tension guide 52. The tension guide 52 has a spring 54 and two longitudinally separable members 56, 58. That longitudinal separation or relative movement is achieved through the provision, in this example, of two bolts and slots (one shown —60) so that when a predetermined tension has been applied to the cable 210, the spring compresses and the bolts can slide in their slots to their other ends, thus signifying adequate tension as having been applied. This prevents an over-tensioning of the cable.

A further loop of the cable 210 is also shown—the loop to which the clamps 1 are attached. This further loop is the one that is hooked onto the cable guides 64 on the mounts 10 to ensure that the poster is correctly tightened across the whole of the aperture of the hoarding.

The cable end that is being tensioned by the winch 44 also has a carbine hook 70 on its end. That carbine hook is attached in this embodiment to a length of rope via a further carbine hook 72. That carbine hook and rope links the cable end to the cable of the winch via the tension guide 52, again by a carbine hook 74—at the other end of the rope.

The length of rope between the two carbine hooks 72, 74 is fed through a tension retaining means—in this embodiment in the form of a cam cleat. This cam cleat has a top sprung cam 80 and a bottom sprung cam 82, which together can grip the rope to allow tensioning—passage in a first direction, but to resist slackening—passage in the opposite direction. However, the cleat is open to the top to allow rapid attachment and detachment simply by pulling inwardly and outwardly the free end of the rope so as to bias the rope into the cleat.

Other forms of cleat or clutch, as commonly used on boats, can also be adopted for this purpose—tension retention.

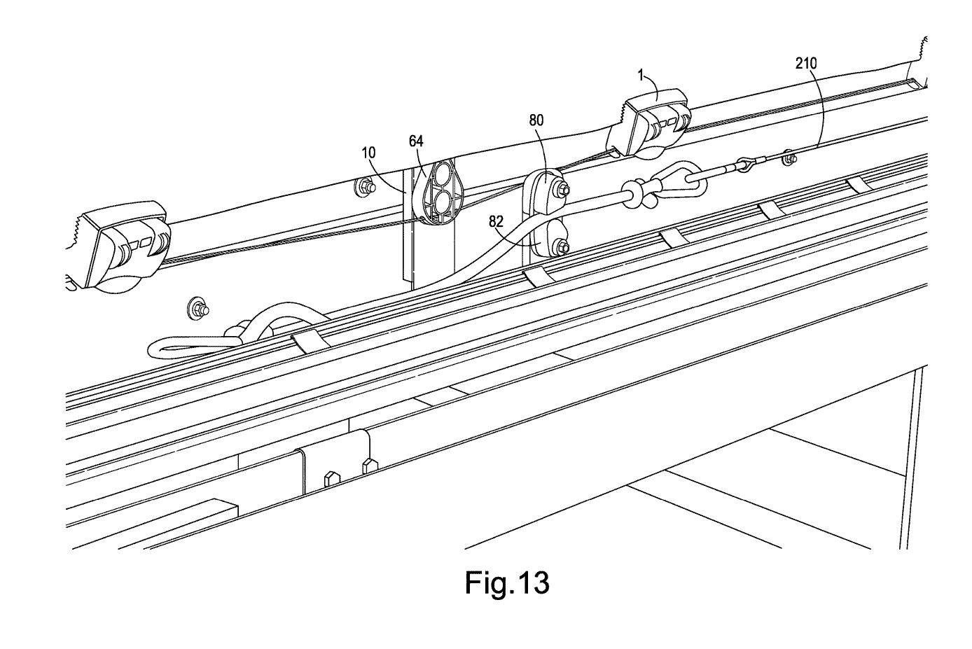

Referring to FIG. 13, the cam cleat of this embodiment can be seen in greater detail.

The opposing faces have grips (serrations) thereon to ensure adequate grip.

The winch, and its carbine hook and the tension guide, have also been disconnected from the rope in FIG. 13 so that the cam cleat is retaining the tension in the cable 210 without the presence of the winch either on the frame or on the hoarding as a whole.

As shown in FIG. 12, which shows one way in which the winch 44 is removable from the frame of the hoarding, the mount for the winch has a flange with a pair of hooks 100, thereon. Those hooks can engage with bolts 102 on a slot mount 104 that is bolted to the frame. The slot mount 104 has a slot 106 into which the flange 108 will slide. The slot is longer than the width of the flange so the flange can slide in and down the slot for engaging the hooks 100 onto the bolts. The hooks are thus directioned such that their return 110 extends in the direction that the flange will move when the pull of the winch applies against the cable end for pulling. This will then lock the flange within the slot so that the hooks, the flange and the winch attached thereto cannot be removed from the bolt 102 when the cable is in tension.

The hoarding might include lighting or a geared winder behind the poster as disclosed in GB1306697.2, the whole contents of which are incorporated herein by way of reference.

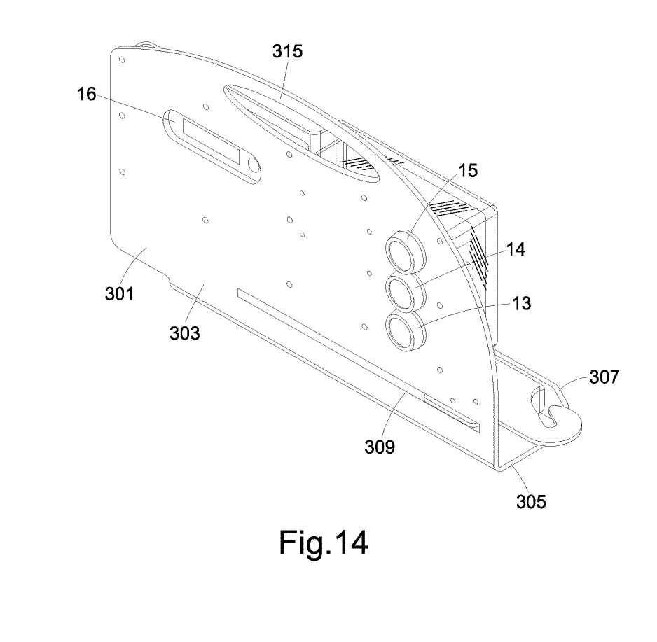

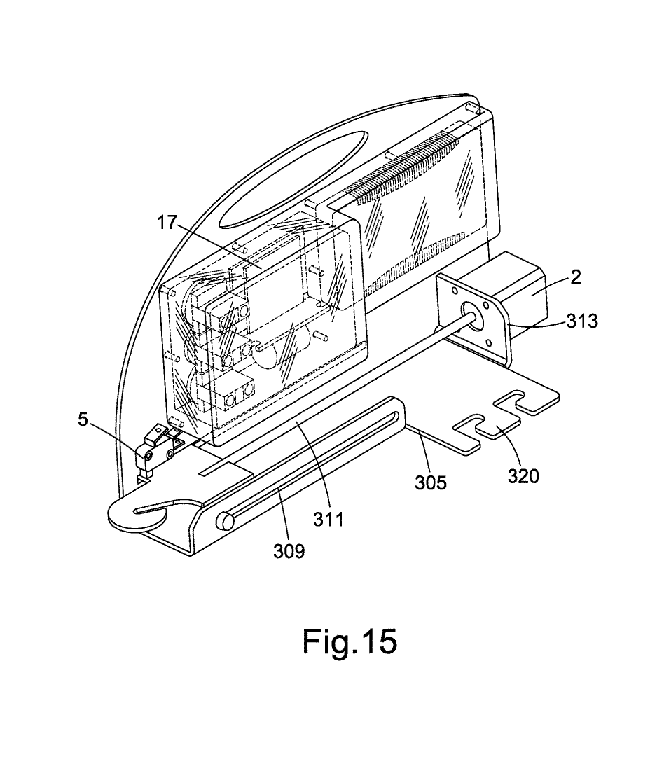

The present invention, however, resides in the provision of an alternative winch—one that can still be attached to the cable system, preferably using a similar pair of hooks to that shown in FIG. 12 for the reel-based winch. See FIGS. 14 and 15 for a preferred arrangement. This winch is disclosed further below, but it is an electric winch.

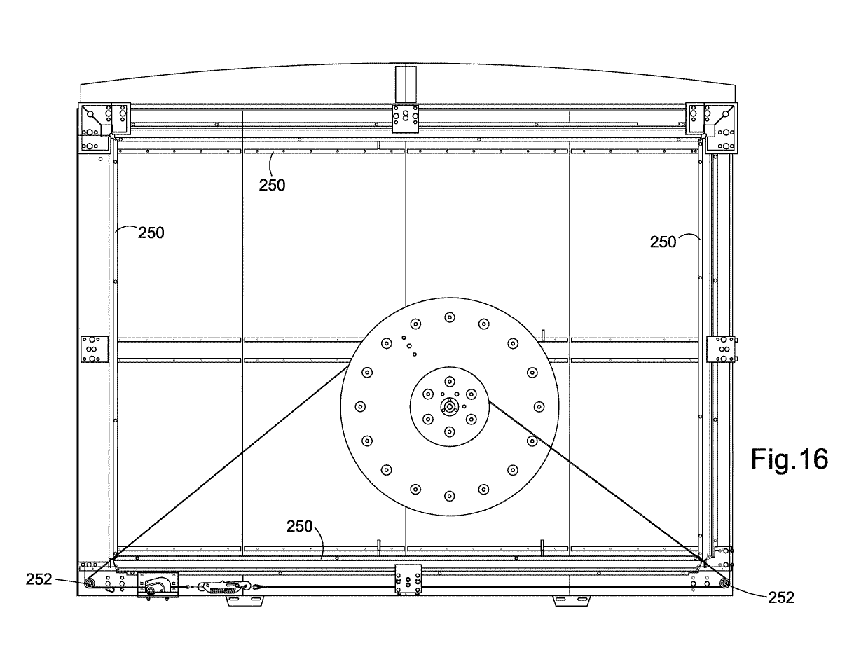

Referring next to FIGS. 16 to 19, a further hoarding is shown, with the poster removed to allow more of the cable pathway and the internal mechanism to be viewed.

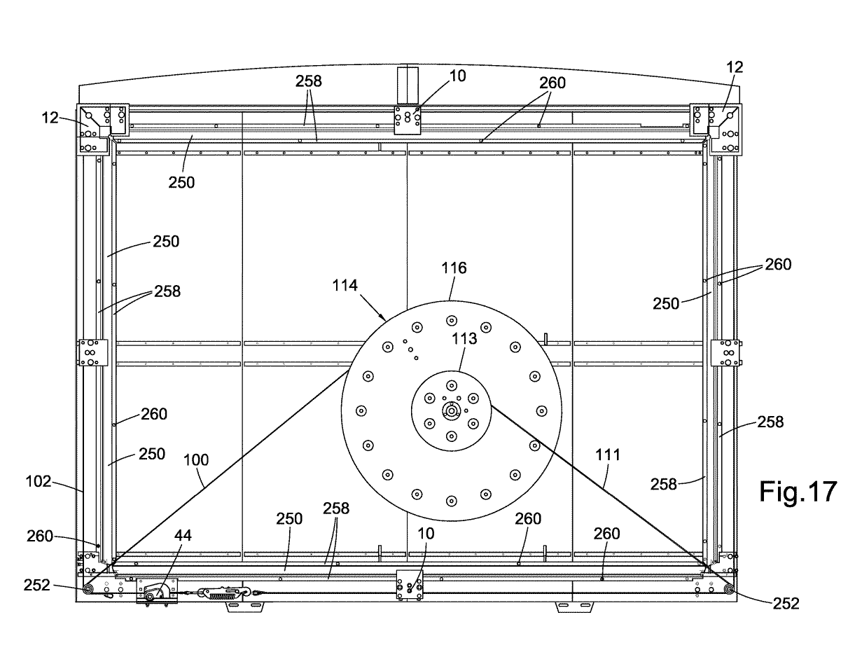

The poster hoarding comprises a cable management system, the cable management system comprising a plurality of spaced cable guides 252 spaced around a perimeter portion of the poster hoarding, in this instance at the four corners. They are pulleys mounted within brackets—FIG. 17 shows the brackets 12 in the top half and the pulleys 252 in the bottom half. Pulleys will also be elsewhere around the perimeter where the size of the hoarding requires it. Since this is a 3 by 4 m hoarding, single additional brackets 10, each having pulleys, located at the midpoints of the sides, top and bottom, may be appropriate, as shown.

The cable management system also has a primary length of cable 100 having a portion 102 that extends around the cable guides 10, 12 around that perimeter when a poster is fitted and tightened within the hoarding.

The cable management system also has a cable tightening mechanism for tightening the poster when fitted, the cable tightening mechanism comprising a mechanism by which a cable tensioning part 111 of the cable tightening mechanism—in this case a further cable 111 and pulley 44—can be pulled or wound up, either directly or indirectly, for tightening the primary cable length 100 between the adjacent cable guides. In this illustrated embodiment the pulley is a reel pulley 44, but that can be replaced with the electric winch of the present invention through a swap-out. An example of such an electric winch, with suitable attachment hooks, is shown in FIGS. 14 and 15.

The cable management system also has a geared winder 114 having a first component 116—a first large reel—for winding up cable slack in that primary cable length 100 as the cable tensioning part 111 is pulled and a smaller second component 113 from which the further cable 111 can be unwound as the cable tensioning part is pulled. The smaller size of that second component 113, i.e. the relative sizes of the first component and the second smaller component, gearing the effect of the pulling if that further cable 111 such that the length of the primary length of cable that is wound up by the first component 116 as the cable tensioning part 111 is pulled is longer than the length of pull and un-wind of the further cable 111 of the cable tensioning part. As a result, a short pull by the winch 44 results in a long pull on the primary cable 100. This has benefits in that it opens up new design options for the winch 44, as explained below.

As can be seen in the figures, this hoarding also has a guide frame 250 fitted to it.

Although optional, it is preferred for assisting with the flattening of a poster as it is tightened.

The guide frame 250 is formed in this example from four members, two down the sides and two across the top and bottom. They may instead be made of multiple components per length, as in PCT/GB2010/000045, the whole contents of which are incorporated herein by way of reference.

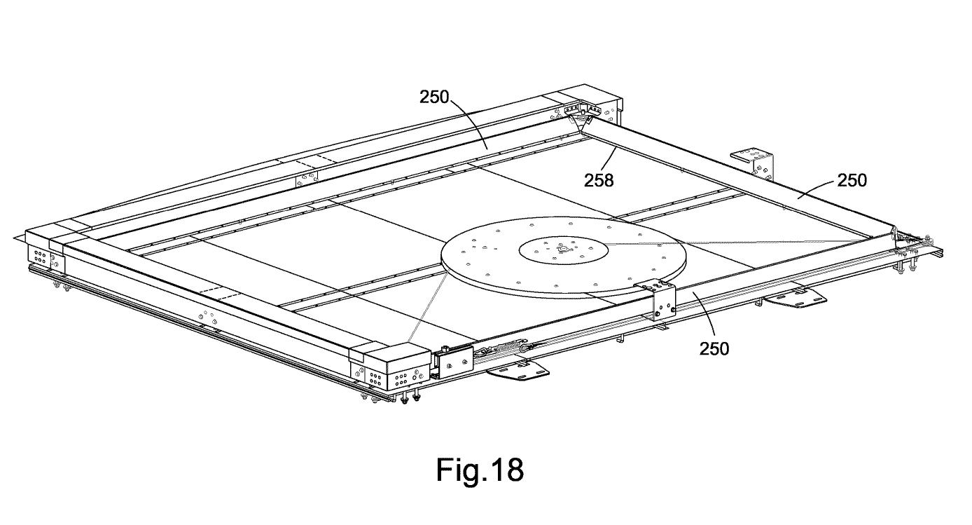

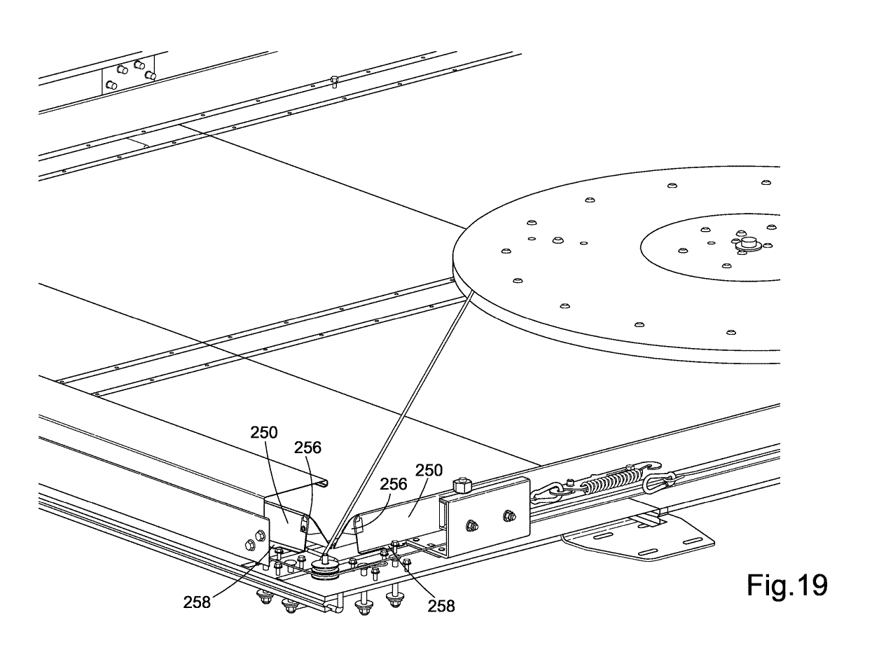

The guide frame members in this example have a generally constant section in the transverse plane relative to the lengths thereof of a single saw-tooth, as can be seen in FIG. 19. The ends, however, in this example have cover members 256 to mask any sharp edges for avoiding or reducing the risk of inadvertent poster rippage.

The tip of the saw-tooth is rounded in this embodiment since in use, or at least while mounting a poster into a hoarding, the poster will rub or slide over the tip of it.

In this embodiment, to the sides of the saw-tooth, flanges 258 extend parallel and in plane relative to one another. They are for attaching the horizontal guide frame members 250 to the back of the hoarding, e.g. with screws. For that purpose, holes 260 are provided.

The substantially constant cross section may be interrupted intermittently along the length of the horizontal guide frame members 250, or the flanges 258, by cut-outs in the flanges. Those cut outs can be needed for receiving the brackets of the pulleys, or the like, around the perimeter of the hoarding. As a result, those brackets will not prevent the guide frame members from sitting flat against the back of the hoarding. Furthermore, the brackets can be mounted as close as possible to the guide frame members, while still also being flat on the back of the hoarding (i.e. rather than overlapping those flanges). This is beneficial since the guide frame functions most efficiently when the respective saw-tooth tips together all form a single flat plane.

Referring now to FIGS. 14 and 15 there is shown an example of an electric winch in accordance with the present invention. Other arrangements are also within the scope of the claim and this embodiment is provided for illustrative purposes only.

As shown in FIG. 14, the winch comprises a main body 301 formed from a folded or moulded sheet of material. It has an outer side wall, or front wall 303, a base wall 305 and an inner upstand 307. The inner upstand 307 is shorter than the outer side wall 303.

Parallel slots 309 are provided in the front wall 303 and inner upstand 307, with the front slot 309 (in the front wall 303) directly facing the rear slot (in the inner upstand 307). The rear slot 309 is more clearly visible in FIG. 15. These slots 309 are used to mount a cable end connector 3 in a fixed orientation relative to the front wall 303 and inner upstand 307, and also the base wall 305 of the winch. This is also so that that cable end connector 3 can slide relative to those walls in a linear manner.

The cable end connector 3 is connected to a threaded rod 311 so as to be movable by a motor 2. The motor 2 is attached to a upstand 313 that extends upwardly from the base wall 305.

The various members of the main body or housing of the winch are preferably bent from a single sheet, with all the respective angles being perpendicular in this embodiment.

The motor 2 is a stepper motor with a worm drive or thread drive internally thereof for linear movement of the rod 311 internally therethrough. As such the motor 2 can pull or push the rod 311 and thus move the cable end connector 3 along the slots 309. By being a stepper motor, the amount of movement is predictable.

A sensor 5 is also provided at one end of the slots in this embodiment. This is so as to sense the position of the cable end connector 3 when at its outermost position. ˜By having this sensor, the winch can be adapted through the control mechanism to prevent the motor 2 from continuing to drive the threaded rod beyond that extended position, thus preventing the rod 311 from extending too far out of the motor 2.

That sensor 5 can simply be a push-to-make button or switch such that as the cable end connector 3 hits a finger of that sensor 5, the sensor can stop the motor 2 via the control system 17 of the motor 2. Other arrangements will be readily apparent to a skilled person.

The motor 2 is also controlled by switches 13, 14 and 15. These switches include a first press button switch 13 for stopping the motor, a second push button switch 14 for causing a release of a poster by extending the rod 311 out of the motor 2, and a third push bottom 15 for tensioning the poster by pulling on the rod 311 through the motor 2. In a preferred arrangement, a single press of these buttons causes a motor status change, although they may be push-to-make switches whereby they have to be held in their depressed position in order to operate the device.

Instead of push buttons there can be other switches such as toggle switches or rocker switches.

The front wall 303 also has a handle 315 for carrying the winch.

The winch also has a programmable motor drive card for allowing the control of the motor 2 to be changed or predefined such as to increase or reduce drive speeds, to increase or reduce movement responses to pressing of buttons and sensors, and also perhaps to respond differently to the status of the battery, or any load sensor indication.

The winch also has a mounting bracket 320 on its base wall 305. This mounting bracket 320 has a hooked member for hooking onto a bolt on the hoarding. This embodiment actually has two hook members for engaging onto the two bolts in the base member of the poster hoarding. This design of mounting bracket thus allows the winch to be used to directly replace the reel winch provided in the previously described embodiments of FIGS. 1, 5 to 12 and 16 to 19.

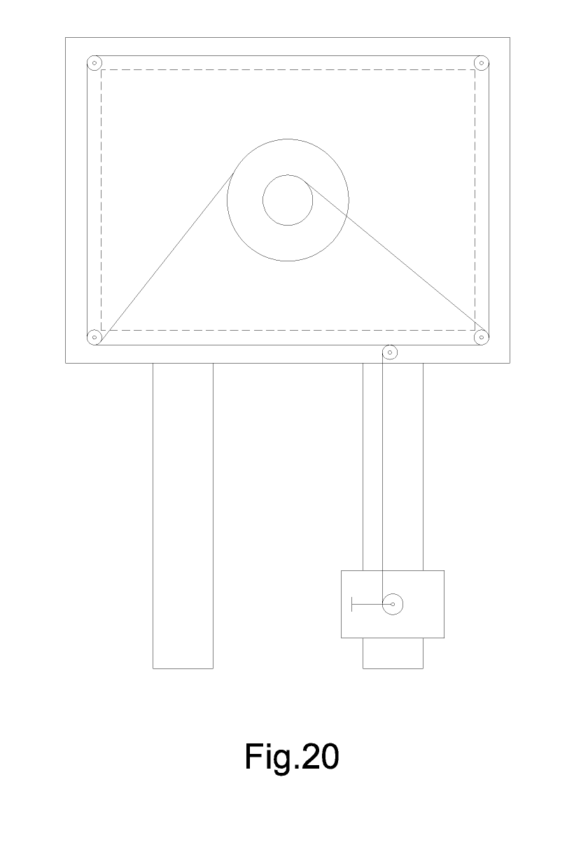

A different mounting bracket will be provided for use in the arrangement of FIG. 20 where the winch is mounted on the leg.

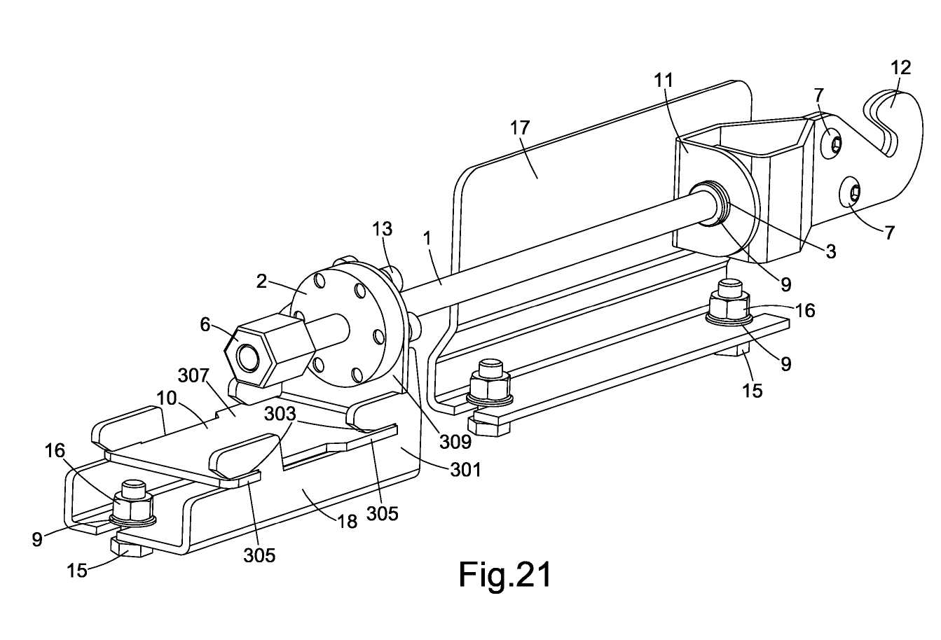

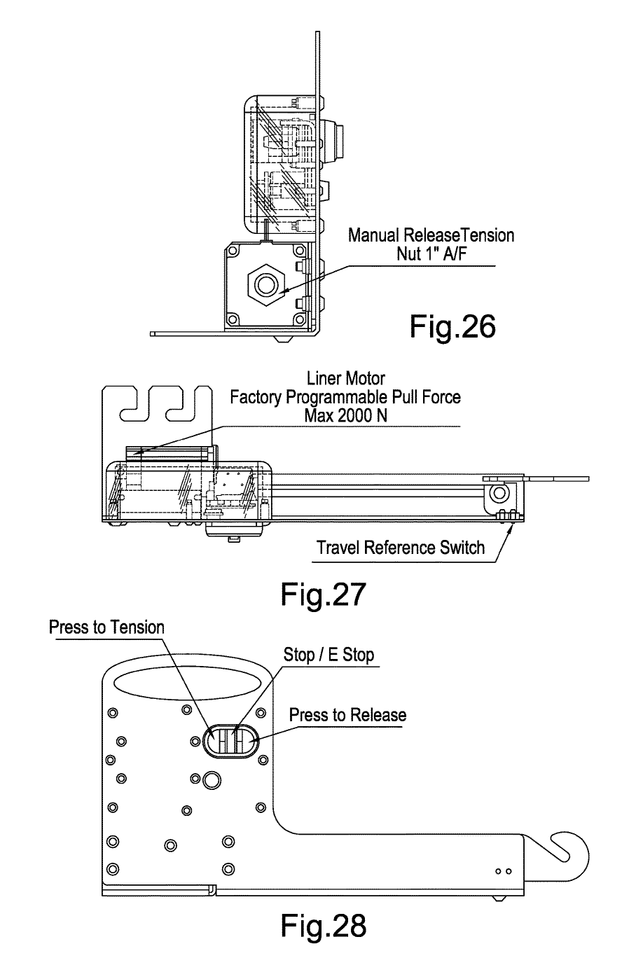

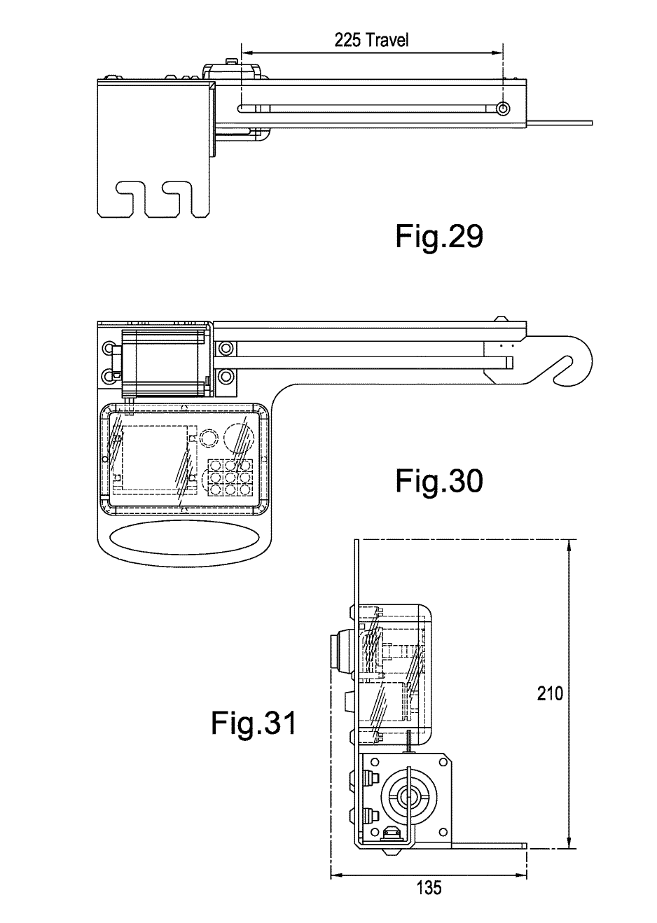

FIG. 20 shows a winch handle, and a reel. However, utilising the same principles as before, that winch can be replaced with an electric winch similar to that disclosed in FIGS. 14 and 15, albeit with a different arrangement for the front wall, base wall and inner upstand and mounting bracket, as suitable for the chosen design of the leg. It can likewise be operated with a winch similar to those of FIGS. 21 to 31, again with the housings modified accordingly given its different mounting requirements. This is as would be understood by a skilled person.

In preferred arrangements, the provision of the motor, a cable end connector and slots for guiding its movement, plus a power supply and means for controlling the motor, would remain the same or similar to that previously described, whenever desired. However, as per FIGS. 21 to 21, the motor and battery (power supply) can be entirely removable.

Referring first to FIGS. 21 to 23, a motorless and batteryless solution is shown. This version can be operated manually using for example a ratchet handle, or in a motorised manner using, for example, a cordless drill.

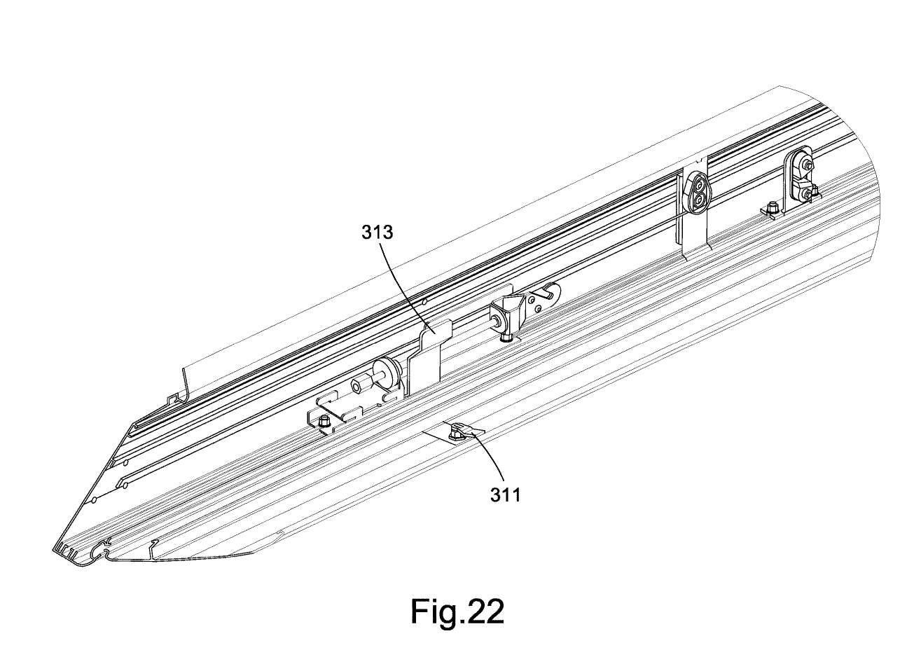

This embodiment comprises a winch mounting bracket 18 that can be bolted to the frame of a poster hoarding—as shown in FIG. 22, using two bolts 15—one shown. It might alternatively be integrally formed onto the frame or welded thereon, but bolts readily allow a retrofit to existing frames.

The mounting bracket 18 has a U-shape in cross section with the bolts on the bottom and two sides, each side 301 featuring slots or hooks 303 for receiving a winch bracket member 10. The winch bracket member 10 has edges with tabs 305 that engage with the slots 303 for securing the base or foot 307 of the bracket member 10 onto the mounting bracket 18 in a removable manner.

The winch bracket member 10 also has an upright member or leg 309. In this embodiment it stands perpendicular to the base 307 and it has bolted or tapped thereto a drive member—in this embodiment it being a nut 2. As shown it is connected using six hexagon socket head cap screws, but other bolts, welds or rivets might be used. It could even be integrally formed—for example a threaded hole within the leg.

The nut 2 is fixed so as not to rotate relative to the leg 309, and it has a threaded hole through it through which the shaft 1 of the winch extends. That shaft is correspondingly threaded such that rotation of the shaft about its axis draws the shaft through the drive member.

The shaft 1 has at one end a further nut 6. This is a chuck-piece for engaging with the chuck of a cordless drill, perhaps via a hex-nut socket piece, or for engaging with a wrench/spanner/ratchet. That then allows the shaft to be rotated about its longitudinal axis for driving it in and out through the drive member 2.

At the far end of the shaft 1 a cable end connector is provided. In this embodiment, the cable end connector again features a hook—as in other embodiments, but it is formed from two plates—a left and right hand plate. These plates are bolted together, although they may be integrally formed from a folded sheet for example, or they may be riveted or welded together. The left hand plate in this embodiment has a flat surface to its side, which serves to engage against a further plate 17 (as described later). It also has a rotatable mounting 3 where the shaft 1 connects thereto. As a result, the cable end connector can rotate relative to the shaft—this differs to the previous embodiment since in this embodiment the shaft is rotated, whereas in the previous embodiment the drive member rotated.

To facilitate the rotation of the cable end connector, the shaft connects thereto at a bush 3 and washer 9.

Rotation of the cable end connector relative to the shaft is further facilitated by the bearing of its left hand piece's flat surface against the further plate 17 or a hook anti rotation bracket 17. That further plate upstands also from the frame and is bolted onto the frame for that purpose—e.g. using two bolts 15 as shown. See FIG. 22. It may instead be riveted, welded or integrally formed onto the frame. It extends parallel to the shaft but perpendicular to the leg 309. It defines a flat line or plane to guide the cable end connector when that cable end connector is tensioning the cable of the poster hoarding. Two surfaces that bear against each other replace the slot of the previous embodiment, but a slot may again be provided. The surfaces need also not be planar—they could be curved for example, albeit still providing a flat or linear profile parallel to the axis of the shaft.

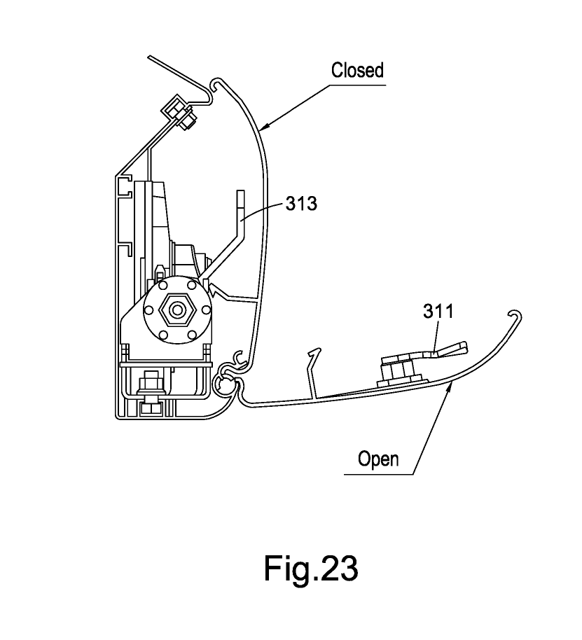

This embodiment is still largely removable from the frame, if desired, since the winch bracket 10 can be removed from the mounting bracket 18, taking with it the shaft and cable end connector (e.g. once the end of the cable is secured in the frame, such as by the previously described cleats—a cleat is shown for that purpose in FIG. 22. That then leaves behind just the mounting bracket 18 and the hook anti-rotation bracket 17. However, referring next to FIG. 23 it can be seen that the frame can be made voluminous enough to leave that winch within the frame—being axially arranged, rather than a more conventional transverse arrangement—as used for reels, it is relatively slimline, thus allowing this non removability, should that be desired.

FIG. 23 also shows a closure clasp 311. It can be rotated, e.g. with a key—to lock behind a retention flange 313. Their relative positions are better shown in FIG. 22. The flange 313 can also be bolted to the frame.

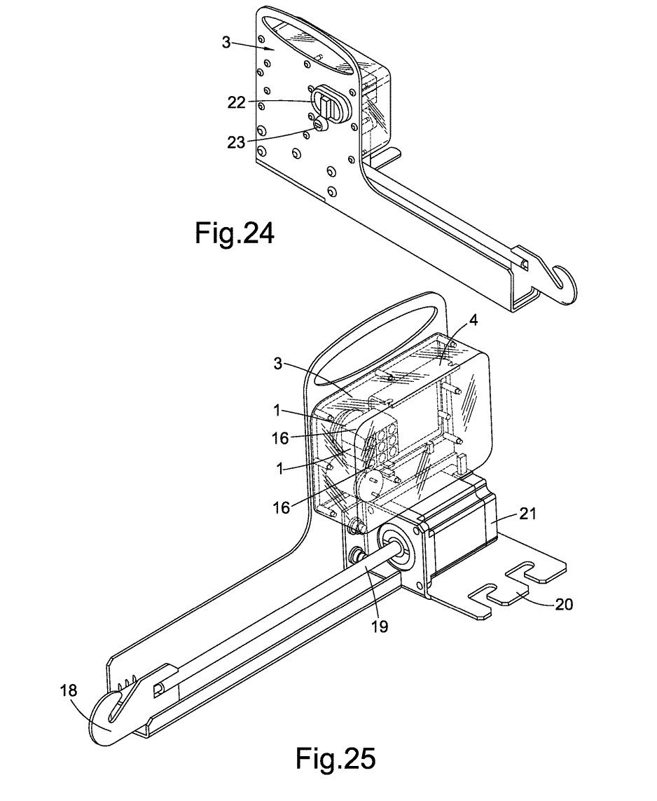

Referring finally to FIGS. 24 to 31, an embodiment similar to that of FIGS. 14 and 15 is shown. It has again got the motor, and a shaft that does not rotate—instead the drive member rotates, but instead of it having an integrated power source, it can take its power from the hoarding's own power supply—it would be hard wired for that purpose. Alternatively it can have a connector provided for a user to connect a battery pack to it, which battery pack can be mounted, for example, on the user's belt.

This further embodiment, like the second, also disposes of the LCD display. It is thus a less costly solution compared to that of the embodiment of FIGS. 14 and 15, albeit a more costly one—due to the motor—than that of FIGS. 21 to 23. It otherwise operates similarly to that of FIGS. 14 to 15, in that it has a motor driving a drive member for drawing the shaft therethrough, thus moving a cable end connector along a path that's controlled by the slot. It is also again removable since it has the pair of hooks for mounting it onto the frame of the hoarding.

The present embodiments are exemplary in nature and various feature omissions, additions or modifications may be made within the scope of the invention as defined in the appended claims. After all, it will be apparent to those skilled in the art that various modifications and variations can be made in the present invention without departing from the scope of the invention. Thus, it is intended that the present invention covers the modifications and variations of this invention provided they come within the scope of the appended claims and their equivalents. For example, references in the claims to a cable, includes a rope or chain or wire.

Table accompanying FIG. 21 as filed:

| ITEM NO. | DESCRIPTION | QTY. |
|---|---|---|
| 1 | T10x2 Shaft | 1 |
| 2 | Tr10x2 Bronze Nut | 1 |
| 3 | 8 mm ID Oilite Bush | 2 |
| 4 | Prevailing torque type hexagon | 1 |
| | nut ISO 7041-M8 | |
| 5 | Washer ISO 7089-6 | 2 |
| 6 | Hex Drive Nut 20 mm A/F | 1 |
| 7 | Hexagon socket button head | 2 |
| | screw ISO 7380-M6 x 16 | |
| 8 | Prevailing torque type hexagon | 2 |
| | nut ISO 7041-M6 | |
| 9 | Washer ISO 7090-8 | 6 |
| 10 | Winch Bracket | 1 |
| 11 | Hook Plate_Right Hand | 1 |
| 12 | Hook Plate_Left Hand | 1 |
| 13 | Hexagon socket head cap | 6 |
| | screw ISO 4762-M6 x 12 | |
| 14 | Hexagon nut with flange ISO | 1 |
| | 4161-M8 | |
| 15 | Hexagon head screw ISO 4017- | 4 |
| | M8 x 20 | |
| 16 | Hexagon nut ISO 4032-M8 | 4 |
| 17 | Hook Anti Rotation Bracket | 1 |
| 18 | Winch Mounting Bracket | 1 |

Table accompanying FIGS. 24 and 25 as filed:

| | | Assy |
|---|---|---|
| ITEM NO. | Description | Dwg/QTY. |
| 1 | 800f_al | 1 |
| 2 | Capacitor 50 v 470uF | 1 |
| 3 | Cover | 1 |
| 4 | Motor Drive Card_SMC135-KCRY | 1 |
| 5 | Manual Release Nut_1inch AF_Hex | 1 |
| 6 | dc2c-Ilrc | 1 |
| 7 | Washer ISO 7089-8 | 1 |
| 8 | ISO 7380-M6 x 16 - 16N | 6 |
| 9 | ISO 7380-M4 x 16 - 16N | 12 |
| 10 | Washer ISO 7089-6 | 6 |
| 11 | ISO 10511-M6-N | 5 |
| 12 | ISO 4029-M6 x 8-N | 2 |
| 13 | ISO 7045-M2 x 10-Z - 10N | 2 |
| 14 | Washer ISO 7089-2 | 2 |
| 15 | 800f_x10_NC | 1 |
| 16 | 800f_x10_NO | 2 |
| 17 | Winch Mounting | 1 |
| | Bracket_3 mm_04.06.2014_Issue G | |
| 18 | Hook Plate_3 mm_04.06.2014_Issue D | 1 |
| 19 | T10x2 Shaft | 1 |
| 20 | Stiffening Bracket_16.06.2014_Issue B | 1 |
| 21 | L5918L3008_T10x2 | 1 |
| 22 | Start_Stop_800f_u3f_f_RS 536-5138 | 1 |
| 23 | Fues Holder | 1 |

1.-4. (canceled)

5. A winch for a poster hoarding, the winch comprising:
a mounting bracket for attachment thereof to a poster hoarding;
a drive member;
a cable end connector for connecting to an end of a cable of the poster hoarding for tensioning a poster on the poster hoarding; and
a shaft, the shaft being connected to the cable end connector and extending in engagement with the drive member, rotation of the drive member relative to or against the shaft drawing the shaft linearly along the shaft's axis.

6. The winch of claim 5, wherein the drive member is one or more worm gear or a threaded hole, or a plurality of planetary gears, designed to engage the shaft for moving the shaft when they rotate, or when the shaft rotates.

7. The winch of claim 5, wherein the shaft is a threaded shaft.

8. The winch of claim 5, wherein the drive member has a hole in it, and the shaft extends through the hole.

9. A winch according to claim 5, wherein the winch is removable from the poster hoarding.

10. (canceled)

11. (canceled)

12. A winch according to claim 5, wherein the winch has an lcd display for indicating the status of the winch.

13. A winch according to claim 5, wherein the cable end connector is in the form of a plate with a connection portion.

14. A winch according to claim 5, wherein the cable end connector comprises a hook.

15. A winch according to claim 5, wherein the cable end connector is mounted in or on a rail or slot.

16. (canceled)

17. A winch according to claim 62, wherein the motor is a stepper motor.

18.-28. (canceled)

29. A winch according to claim 5, wherein the range of extension and retraction of the cable end connector in the winch does not exceed 60 cm.

30.-32. (canceled)

33. A winch according to claim 5, wherein the mounting bracket comprises at least two hooks for notching onto two bolts on the hoarding.

34.-38. (canceled)

39. A poster hoarding comprising a cable management system, the cable management system comprising a plurality of spaced cable guides spaced around a perimeter portion of the poster hoarding, and a cable for the poster, wherein the poster hoarding has a primary length of cable having a portion that will extend around cable guides around that perimeter when a poster is fitted and tightened within the hoarding, and a cable tightening mechanism for tightening the poster when fitted, the cable tightening mechanism comprising a winch, by which a cable tensioning part can be pulled, either directly or indirectly, for tightening the primary cable length between the adjacent cable guides, wherein the winch comprises a mounting bracket for attachment thereof to a poster hoarding, a drive member, a cable end connector for connecting to an end of a cable of the poster hoarding for tensioning a poster on the poster hoarding, and a shaft, the shaft being connected to the cable end connector and extending in engagement with the drive member, rotation of the drive member relative to or against the shaft drawing the shaft linearly along the shaft's axis.

40. A poster hoarding according to claim 39, wherein the cable tightening mechanism further comprises a geared winder having a first component for winding up cable slack in that primary length of cable as the cable tensioning part is pulled and a smaller second component from which cable can be unwound as the cable tensioning part is pulled, the relative sizes of the first component and the second smaller component gearing the effect of the pulling such that the length of the primary length of cable that is wound up by the first component as the cable tensioning part is pulled is longer than the length of pull of the cable tensioning part.

41. A poster hoarding according to claim 39, wherein the cable tensioning part is a cable end and the cable end has a carbine hook on its end for quick connection to the winch's cable end connection.

42. (canceled)

43. A poster hoarding according to claim 39, wherein there are at least two distinct cables, one defining the primary length of cable and the other defining the cable tensioning part.

44. A poster hoarding according to claim 39, wherein a cable tension retention mechanism is provided on the hoarding for securing the tension in the cable for a fitted poster, whereupon the winch can removable without loss of tension in the cable of the poster hoarding, the cable tension retention mechanism being one or more of a cleat, a clutch or a rope jamming mechanism.

45.-51. (canceled)

52. A poster hoarding having a cable based poster tensioning mechanism therein, the poster tensioning mechanism comprising a length of cable, rope or chain that runs along a leg or arm of the poster hoarding to a cable tensioning point, the cable tensioning point being adapted to allow a cable tensioning mechanism to be used for pulling the cable, rope or chain for tensioning the cable, rope or chain to tighten a poster, the cable tensioning mechanism comprising a winch the winch comprising a mounting bracket for attachment thereof to a poster hoarding, a drive member, a cable end connector for connecting to an end of a cable of the poster hoarding for tensioning a poster on the poster hoarding, and a shaft, the shaft being connected to the cable end connector and extending in engagement with the drive member, rotation of the drive member relative to or against the shaft drawing the shaft linearly along the shaft's axis.

53.-61. (canceled)

62. The winch of claim 5, further comprising a motor for providing relative rotation between the drive member and the shaft.

63. The winch of claim 62, comprising an electrical power source for driving the motor.
